(19) United States
(12) Patent Application Publication
(10) Pub. No.: US 2024/0208594 A1
(43) Pub. Date: Jun. 27, 2024

(54) ATTACHMENT SYSTEM FOR BUMPER OF WORK VEHICLE

(71) Applicant: CNH Industrial America LLC, New Holland, PA (US)

(72) Inventor: Thomas James Paulson, Fargo, ND (US)

(21) Appl. No.: 18/087,939

(22) Filed: Dec. 23, 2022

(51) Int. Cl. B62D 49/08; B60R 19/48

(52) U.S. Cl. CPC B62D 49/085; B60R 19/48

(57) ABSTRACT

An attachment system for a bumper of a work vehicle includes a bumper interface. The bumper interface is configured to support a substantially downward load exerted by an attachment interface. The bumper interface includes a bumper pin retainer configured to retain a pin. The pin is configured to couple to the attachment interface. The pin is also configured to transfer the substantially downward load exerted by the attachment interface to the bumper interface. The bumper interface also includes a bumper anti-rotation feature configured to block rotation in a first direction of the attachment interface about the pin.

### BACKGROUND

The present disclosure relates generally to an attachment system for a bumper of a work vehicle.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In farming applications, ballast and/or an implement is frequently rigidly attached to a front of a work vehicle. Due to these attachments often being heavy and unwieldy, conventional processes for attaching ballast and/or an implement may be time-consuming and/or involve multiple attempts.

### BRIEF DESCRIPTION

This summary is provided to introduce a selection of concepts that are further described below in the detailed description. This summary is not intended to identify key or essential features of the claimed subject matter, nor is it intended to be used as an aid in limiting the scope of the claimed subject matter.

In certain embodiments, an attachment system for a bumper of a work vehicle includes a bumper interface. The bumper interface is configured to support a substantially downward load exerted by an attachment interface. The bumper interface includes a bumper pin retainer configured to retain a pin. The pin is configured to couple to the attachment interface. The pin is also configured to transfer the substantially downward load exerted by the attachment interface to the bumper interface. The bumper interface also includes a bumper anti-rotation feature configured to block rotation in a first direction of the attachment interface about the pin.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a work vehicle having an attachment system for a bumper of the work vehicle, in accordance with an aspect of the present disclosure;

FIG. 2 is a perspective view of an embodiment of the attachment system that may be employed within the work vehicle of FIG. 1, in accordance with an aspect of the present disclosure;

FIG. 3 is an exploded view of the attachment system of FIG. 2, in accordance with an aspect of the present disclosure; and

FIG. 4 is a cross-sectional view of the attachment system of FIG. 2, taken along line 4-4 of FIG. 2, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising.” “including.” and “having” are intended to be inclusive and mean that there may be additional elements other than the listed elements. Any examples of operating parameters and/or environmental conditions are not exclusive of other parameters/conditions of the disclosed embodiments.

As described in detail below, attaching ballast and/or an implement to a work vehicle may be accomplished by using an attachment system having a bumper interface (e.g. secured to the work vehicle) and an attachment interface (e.g. coupled to the ballast and/or implement). In a certain embodiment, the bumper interface includes a first pin retaining feature, and the attachment interface includes a second pin retaining feature. The pin retaining features of the interfaces are configured to concurrently retain a pin, thereby blocking downward translational motion of the attachment interface (e.g. weights, etc.) relative to the bumper interface and enabling the attachment interface to rotate about the pin relative to the bumper interface. The bumper interface and the attachment interface each include an anti-rotation feature that, when engaged with one another, block downward rotation of the attachment interface (e.g. weights, etc.) about the pin relative to the bumper interface. As a result, downward rotation and translation of the attachment interface (e.g. weights, etc.) relative to the bumper interface are blocked.

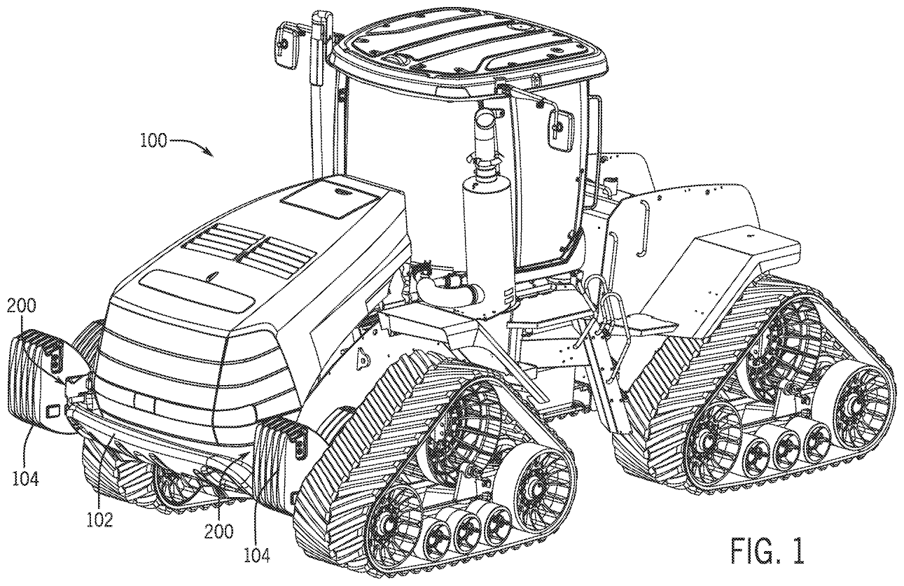

With the foregoing in mind, FIG. 1 is a perspective view of an embodiment of a work vehicle 100 having an attachment system 200 for a bumper 102 of the work vehicle 100, in accordance with an aspect of the present disclosure. In the illustrated embodiment, the bumper 102 is configured to carry weights 104 via the attachment system 200. The weights 104 may be composed of a high-density material (e.g. steel, cast iron). The bumper 102 is configured to support the load exerted by the weights 104. The bumper 102 may be composed of metal with high tensile strength (e.g. steel, titanium, aluminum) or, in certain embodiments, a high-strength composite (e.g. carbon fiber). The bumper 102 may be a single fabrication (e.g. casting) or may include several fabricated (e.g. cast) parts fastened (e.g. welded, bolted, etc.) to one another. In certain embodiments, the attachment system 200 may be configured to mount a variety of attachments (e.g. the weights 104, fertilizer tank(s), sprayer(s), etc.) to the work vehicle 100. In certain embodiments, the attachment system 200 may be used to mount attachments on the sides of the bumper 102, on the front side of the bumper 102, on the rear side of the bumper 102, or a combination thereof.

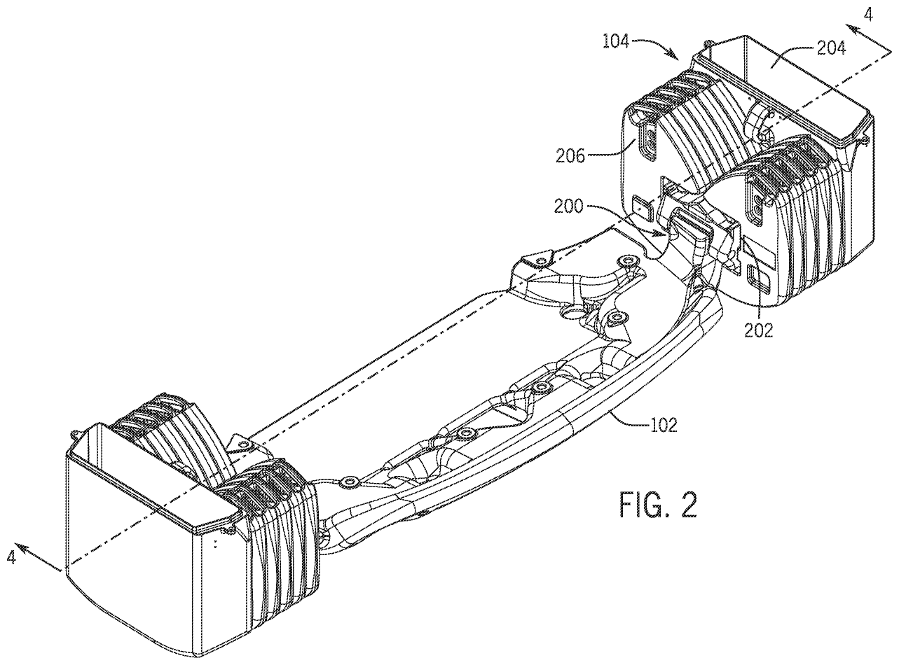

FIG. 2 is a perspective view of an embodiment of the attachment system 200 that may be employed within the work vehicle of FIG. 1, in accordance with an aspect of the present disclosure. In the illustrated embodiment, the bumper 102 is outfitted with two separate attachment systems 200, each configured to carry a weight attachment 202. In the illustrated embodiment, the weight attachments 202 each include an outer weight 204 positioned (e.g. fixed, attached, etc.) on the outermost side of the weight attachment 202. As depicted in the illustrated embodiment, wing weights 206 are configured to couple to the weight attachments 202. In certain embodiments, the wing weights 206 may be thinner (e.g. lighter) compared to the outer weight(s) 204, and configured to be easily removed from the weight attachment 202, so as to adjust the amount of ballast carried by the bumper 102. The wing weights 206 may be configured to be secured to one another, such that more than one wing weight 206 may be added and/or removed at one time. In certain embodiments, the wing weights 206 may include weights of varying thicknesses (e.g. varying loads).

In certain embodiments, the bumper 102 and the attachment system 200 may be configured to support a wide range of loads exerted by the weights 104, which in certain embodiments may include outer weight 204 and/or wing weights 206. For example, when applying fertilizer, the load exerted by the fertilizer tanks (e.g., weights 104) may vary greatly as the fertilizer in the tanks is depleted over time. In certain embodiments, the attachment system 200 may be configured to rigidly couple the weight attachments 202 with and without additional weight(s) 104, such that the weight attachments 202, weight(s) 104, outer weight 204, and wing weights 206 are rigidly secured during motion of the agricultural vehicle, regardless of the amount of weight coupled to the weight attachments 202.

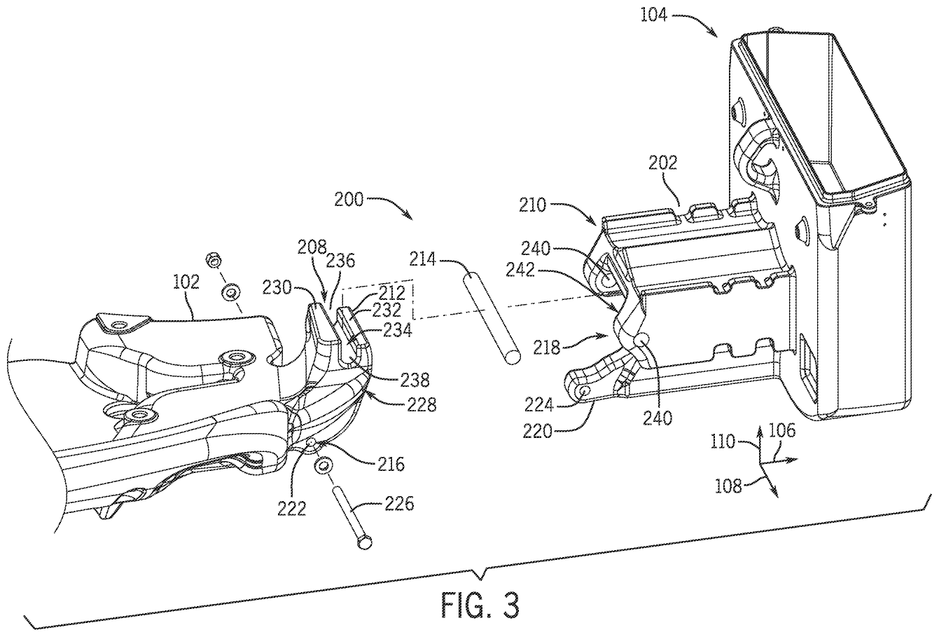

FIG. 3 is an exploded view of the attachment system 200 of FIG. 2, in accordance with an aspect of the present disclosure. The attachment system 200 includes a bumper interface 208 and an attachment interface 210. In the illustrated embodiment, the bumper 102 includes the bumper interface 208 and the weight attachment 202 includes the attachment interface 210. The bumper interface 208 is configured to couple to (e.g. engage, fasten to, etc.) the attachment interface 210, and vice versa.

In the illustrated embodiment, the bumper interface 208 is configured to support a load (e.g. in a substantially downward direction) exerted by the weights 104 and the weight attachment 202 via a pin 214 (e.g., fastener) of the attachment system 200. The bumper interface 208 includes a bumper pin retainer 212. The bumper pin retainer 212 is configured to retain (e.g. secure, hold, etc.) the pin 214. The pin 214 is configured to couple to the attachment interface 210 and is configured to transfer the substantially downward load exerted by the attachment interface 210 to the bumper interface 208. The bumper interface 208 also includes a bumper anti-rotation feature 216 configured to block downward rotation of the weights 104, the attachment interface 210, and the weight attachment 202 about the pin 214.

In the illustrated embodiment, the attachment interface 210 is configured to transfer the load (e.g. substantially downward) exerted by the weights 104 to the pin 214. The attachment interface 210 includes an attachment pin retainer 218. The attachment pin retainer 218 is configured to retain (e.g. secure, hold, etc.) the pin 214. The pin 214 is configured to couple to the bumper interface 208. The pin 214 is also configured to transfer the substantially downward load from the weights 104 to the bumper interface 208. The attachment interface 210 also includes an attachment anti-rotation feature 220 configured to block the downward rotation of the weights 104, the attachment interface 210, and the weight attachment 202 about the pin 214. Transferring the downward load exerted by the weights 104 through pin 214, as opposed to through a solid structural feature, may enable the pin 214 to break in response to an excessive load, thereby reducing the cost associated with repairing the work vehicle (e.g., only replacement of the pin).

In the illustrated embodiment, the bumper anti-rotation feature 216 is configured to make physical contact with the attachment anti-rotation feature 220 of the attachment interface 210. The bumper anti-rotation feature 216 is configured to support a load exerted by the attachment anti-rotation feature 220 (e.g. transferred from the weights 104). In the illustrated embodiment, the bumper anti-rotation feature includes a first bumper anti-rotation feature arm and a second bumper anti-rotation feature arm separated by a gap. The attachment anti-rotation feature 220 includes an attachment anti-rotation feature arm 221. The width of the gap is larger than (e.g. defined by) the width of the attachment anti-rotation feature arm 221, such that the attachment anti-rotation feature arm 221 is configured to fit in the gap (e.g. between the two bumper anti-rotation feature arms).

In the illustrated embodiment, the bumper anti-rotation feature 216 includes hole(s) 222, and the attachment anti-rotation feature 220 includes hole(s) 224, that when aligned, are configured to retain (e.g. hold, secure, etc.) a bolt 226 (e.g., fastener) to block a rotation (e.g. upward and downward) of the weights 104, the attachment interface 210 and the weight attachment 202 about the pin 214. The nut 227 retains the bolt 226 and washers 229 distribute the load from weights 104 over a wider area of the anti-rotation features. Although the holes of the anti-rotation features receive a bolt in the illustrated embodiment, in other embodiments, a pin may be retained in the anti-rotation holes and serve the same purpose as the bolt.

In the illustrated embodiment, the bumper pin retainer 212 includes a hook feature 228 that includes a first hook feature arm 230 and a second hook feature arm 232 separated by an open slot 234. The hook feature 228 is configured to receive the pin 214 via an open end 236 of the open slot 234. The hook feature 228 is configured to engage the pin 214 at a closed end 238 of the open slot 234, which is between the first hook feature arm 230 and the second hook feature arm 232, at the first hook feature arm 230, and at the second hook feature arm 232. The closed end 238 of the open slot 234 is located at a lower height (e.g. relative to the ground) than the open end 236 of the open slot 234, such that the pin 214 (e.g. retained by the attachment interface 210) may slide into the open slot 234. In the illustrated embodiment, the attachment pin retainer 218 includes two eyelets 240 (e.g. fully encircled apertures) separated by an eyelet gap 242. The width of the hook feature 228 is configured to be (e.g. defined to be) slightly smaller than the width of the eyelet gap 242, thereby enabling the hook feature 228 to retain the exposed portion of the pin 214 between the two eyelets 240. The pin 214 is retained by the first eyelet 240, retaining one end of the pin 214 and the second eyelet 240, retaining the other end of the pin 214. The middle portion of the pin 214 exposed by the eyelet gap 242 is retained by the hook feature 228 of the bumper pin retainer 212.

The process of attaching attachment interface 210 to the bumper interface 208 begins by lifting the attachment interface 210 and weights 104 (e.g., via a crane) and aligning the pin 214 with the open slot 234 of the bumper interface 208. The attachment interface is lowered vertically, thereby lowering the pin 214 into the open slot 234. The attachment interface 210 is then rotated downward about the pin 214, such that the hole(s) 222 of the bumper anti-rotation feature 216 align with hole(s) 224 of the attachment anti-rotation feature 220. A bolt 226 is then inserted into hole(s) 222, 224, such that the bolt is concurrently retained by hole(s) 222, 224, thereby blocking rotation of the attachment interface 210 about the pin 214.

In certain embodiments, the length of the pin may exceed the length between the outermost sides of the eyelets, thereby establishing an overhang of the pin on the outermost side of each eyelet. The pin may be configured with a through-hole at each of the overhangs, thereby enabling the pin to be secured to the bumper pin retainer using two securing fasteners (e.g., lock pins, nuts, clips, etc.). One securing fastener may be inserted into the first through-hole of the first overhang, and the second securing fastener may be inserted into the second through-hole of the second overhang, thereby blocking the pin from sliding out of the eyelets. In certain embodiments, the pin may be integrally formed with either of the pin retainers.

In the illustrated embodiment, the attachment interface 210 is rigidly coupled to the bumper interface 208 in response to the bumper pin retainer 212 and the attachment pin retainer 218 concurrently retaining the pin 214, and a concurrent coupling of the bumper anti-rotation feature 216 and the attachment anti-rotation feature 220 (e.g. via a pin, bolt, etc.). The attachment interface 210 is rigidly coupled to the bumper interface 208, such that all three translational degrees of freedom and all three rotational degrees of freedom are substantially constrained. The pin 214, bumper retainer 212, and attachment pin retainer 218 block translational motion of the attachment interface 210 relative to the bumper interface 208 in the longitudinal direction 106, lateral direction 108, and vertical direction 110, as well as rotational motion about longitudinal axis 106 and vertical axis 110. The bumper anti-rotation feature 216 and the attachment anti-rotation feature 220 block rotational motion of the attachment interface 210 relative to the bumper interface 208 about the lateral axis 108.

In certain embodiments, the bumper pin retainer may include two eyelets separated by an eyelet gap. The pin may be retained via one eyelet retaining one end of the pin and the second eyelet retaining the other end of the pin. The middle portion of the pin exposed by the eyelet gap may engage the attachment pin retainer. In certain embodiments, the attachment pin retainer may include a hook feature that may include a first arm and a second arm separated by an open slot. The width of the hook feature may be configured to be smaller than the width of the eyelet gap (e.g. defined by the width of the eyelet gap), thereby enabling the hook feature to retain the exposed portion of the pin between the two eyelets of the bumper pin retainer. The hook feature may be configured to receive the pin via an open end of the open slot. The hook feature may be configured to engage the pin at a closed end of the open slot, which is between the first arm and the second arm, at the first hook feature, and at the second hook feature. The closed end of the open slot may be located at a greater height (e.g. relative to the ground) than the open end of the open slot, such that the hook feature can be disposed over the pin.

In certain embodiments, the attachment anti-rotation feature may include a first attachment anti-rotation feature arm and a second attachment anti-rotation feature arm separated by a gap. The bumper anti-rotation feature may include a single bumper anti-rotation feature arm. The width of the gap may be slightly larger than (e.g. defined by) the width of the bumper anti-rotation feature arm (e.g. defined by the width of the bumper anti-rotation feature), such that the bumper anti-rotation feature arm is configured to fit within the gap (e.g. between the two attachment anti-rotation feature arms).

In the illustrated embodiment, the bumper anti-rotation feature 216 is configured to align the hole(s) 222 with the hole(s) 224 of the attachment anti-rotation feature 220 in response to the attachment anti-rotation feature 220 making physical contact with the bumper anti-rotation feature 216. In this manner, the bolt 226 may be inserted through the hole(s) 222 and the hole(s) 224 so that both anti-rotation features retain the bolt 226, thus blocking upward rotation of the weights 104, the weight attachment 202, and the attachment interface 210 about the pin 214. The bumper anti-rotation feature 216 may be configured to support the load exerted by the weights 104 (e.g. via the attachment anti-rotation feature 220). The attachment anti-rotation feature 220 may be configured to support the reaction load exerted by the bumper anti-rotation feature 216 (e.g., due to the work vehicle encountering uneven/bumpy terrain).

In certain embodiments, the bumper anti-rotation feature may include a latch which blocks rotation of the weights, the weight attachment, and the attachment interface about the pin in response to the attachment anti-rotation feature exerting a sufficient load onto the bumper anti-rotation feature. Upon the sufficient load being applied (e.g., via gravity, urging the attachment anti-rotation feature to rotate about the pin), the latch may automatically engage, thereby securing the attachment anti-rotation feature to the bumper anti-rotation feature. The latch may include a spring-loaded mechanism that automatically activates upon the sufficient load being applied to the mechanism. A latch that automatically engages in response to a sufficient load exerted by the attachment anti-rotation feature obviates the extra step of securing the attachment anti-rotation feature to the bumper anti-rotation feature with the bolt. In certain embodiments, the attachment anti-rotation feature may include the aforementioned latch (e.g., instead of the bumper anti-rotation feature). The aforementioned latch is configured to block rotation of the weights and the attachment interface about the pin without additional bolt(s), washer(s), and nut(s).

In certain embodiments, the bumper anti-rotation feature may include a latch which blocks rotation of the weights, the weight attachment, and the attachment interface about the pin in response to a user manually engaging (e.g. turning, pushing, etc.) the latch. In this manner, after the attachment anti-rotation feature makes physical contact with the bumper anti-rotation feature, the user may engage the latch, thereby securing the attachment anti-rotation feature to the bumper anti-rotation feature. No additional components (e.g. bolts, nuts, washers) or tooling may be used to secure the attachment anti-rotation feature to the bumper anti-rotation. In certain embodiments, the attachment anti-rotation feature may include the aforementioned latch (e.g., instead of the bumper anti-rotation feature). The aforementioned latch is configured to block rotation of the weights and the attachment interface about the pin without additional bolt(s), washer(s), and nut(s).

In certain embodiments, the bumper pin retainer may include two eyelets separated by an eyelet gap. The pin may be retained by the first eyelet retaining one end of the pin and the second eyelet retaining the other end of the pin. In certain embodiments the pin may be welded to the eyelets. Additionally or alternatively, the length of the pin may exceed the length between the outermost sides of the eyelets, thereby establishing an overhang of the pin on the outermost side of each eyelet. The pin may be configured with a through-hole at each of the overhangs, thereby enabling the pin to be secured to the bumper pin retainer using two securing fasteners (e.g., lock pins, nuts, clips, etc.). One securing fastener may be inserted into the first through-hole of the first overhang, and the second securing fastener may be inserted into the second through-hole of the second overhang, thereby blocking the pin from sliding out of the eyelets. In certain embodiments, the pin may be integrally formed with either of the pin retainers.

In certain embodiments, the bumper pin retainer may include two hook features, each of which may include a first arm and a second arm separated by an open slot. The hook features may be separated by a gap, such that the first hook feature retains one end of the pin and the second hook feature retains the second end of the pin. Each hook feature may be configured to engage the pin at a closed end of the open slot, which is between the first arm and the second arm of the hook feature, at the first hook feature arm, and at the second hook feature arm. The closed ends of the open slots may be located at a lower height (e.g. relative to the ground) than the open ends of the open slots, such that the pin (e.g. retained by the attachment interface) may slide into the open slots. In certain embodiments, the attachment pin retainer may include a single eyelet which may retain the pin. The width of the eyelet may be configured to be smaller than the width of the gap between the hook features, thereby enabling the eyelet to fit between the two hook features. The pin may be configured to overhang from both sides of the eyelet, such that the overhanging portions of the pin may be retained by the two hook features on both sides of the eyelet.

In certain embodiments, the bumper pin retainer may include a single eyelet configured to retain the pin. The pin may be configured to overhang both sides of the eyelet. In certain embodiments, the attachment pin retainer may include two hook features, each of which may include a first arm and a second arm separated by an open slot. The hook features may be separated by a gap, such that the first hook feature retains one end of the pin and the second hook feature retains the second end of the pin. The width of the eyelet may be configured to be slightly smaller than the width of the gap, such that the eyelet may fit between the two hook features. Each hook feature may be configured to engage the pin at the closed end of the open slot, which is between the first arm and the second arm of the hook feature, at the first hook feature arm, and at the second hook feature arm. The closed ends of the open slots may be located at a greater height (e.g. relative to the ground) than the open ends of the open slots, such that the hook features may be disposed over the overhanging portions of the pin, one hook feature on either side of the eyelet of the bumper pin retainer.

In certain embodiments, the bumper pin retainer may include two eyelets separated by a gap, such that one eyelet retains one end of the pin and the second eyelet retains the second end of the pin. The attachment pin retainer may include a third eyelet which also retains the pin. The width of the third eyelet may be smaller than the width of the gap between the two eyelets of the bumper pin retainer (e.g. defined by the width of the gap), thereby enabling the third eyelet to retain the exposed portion of the pin between the two eyelets of the bumper pin retainer. Because both the bumper pin retainer and the attachment pin retainer both include eyelet(s), the pin may be configured to slide into the eyelets of both the bumper pin retainer and the attachment pin retainer once the eyelets are aligned. Once positioned, the pin may be secured via retaining mechanisms (e.g. collet pin(s), clip(s), lock nut(s), etc.).

In certain embodiments, the attachment pin retainer may include two eyelets separated by a gap, such that one eyelet retains one end of the pin and the second eyelet retains the second end of the pin. The bumper pin retainer may include a third eyelet which also retains the pin. The third eyelet may be smaller in width than the gap between the two eyelets of the attachment pin retainer, thereby enabling the third eyelet to retain the exposed portion of the pin between the two eyelets of the attachment pin retainer. Because both the bumper pin retainer and the attachment pin retainer both include eyelet(s), the pin may be configured to slide into the eyelets of both the bumper pin retainer and the attachment pin retainer once the two eyelets are aligned. Once positioned, the pin may be secured via retaining mechanisms (e.g. collet pin(s), clip(s), lock nut(s), etc.).

In certain embodiments, the bumper interface may include alignment feature(s) to facilitate aligning eyelet(s) of the attachment pin retainer with eyelet(s) of the bumper pin retainer. In certain embodiments, the bumper interface may include two alignment features located on either side of the bumper pin retainer (e.g. bumper eyelet), which may be configured to engage (e.g. guide, maneuver) the eyelets of the attachment pin retainer to align with the eyelet of the bumper pin retainer. In certain embodiments, the bumper interface may include one alignment feature located between portions of the bumper pin retainer (e.g. between two separate bumper eyelets), which may be configured to engage (e.g. guide, maneuver) a single eyelet of the attachment pin retainer to align with the eyelets of the bumper pin retainer. Such alignment may save substantial time in alignment of the interfaces. In certain embodiments, the alignment features may be indentations which take the shape of the outer portion(s) of one or more eyelets. By aligning the one or more eyelets with the respective indentations, the eyelet(s) may be more easily positioned to align with eyelet(s) of the opposing interface.

In certain embodiments, the attachment interface may include alignment feature(s) to facilitate aligning eyelet(s) of the bumper pin retainer with eyelet(s) of the attachment pin retainer. In certain embodiments, the attachment interface may include two alignment features located on either side of the attachment pin retainer (e.g. attachment eyelet), which may be configured to engage (e.g. guide, maneuver) the eyelets of the bumper pin retainer to align with the eyelet of the attachment pin retainer. In certain embodiments, the attachment interface may include one alignment feature located between portions of the attachment pin retainer (e.g. between two separate attachment eyelets), which may be configured to engage (e.g. guide, maneuver) a single eyelet of the bumper pin retainer to align with the eyelets of the attachment pin retainer. Such alignment may save substantial time in alignment of the interfaces. In certain embodiments, the alignment features may be indentations which take the shape of the outer portion(s) of one or more eyelets. By aligning the one or more eyelets with the respective indentations, the eyelet(s) may be more easily positioned to align with eyelet(s) of the opposing interface.

In certain embodiments, the hook feature may include a latch that may be engaged (e.g. manually) in response to the pin being retained by the hook feature, such that the pin is fully encircled by the hook feature. In this manner, the latch may block the open end of the open slot, thereby blocking the pin from disengaging the hook feature via the open end of the open slot.

In certain embodiments, the attachment system may include a bored hole extending from the hook feature to the hole(s) of the bumper anti-rotation feature. The bored hole may be configured to receive a support bolt. In certain embodiments, the bumper anti-rotation feature and the attachment anti-rotation feature may be configured to receive the support bolt, such that the support bolt secures the attachment anti-rotation feature to the bumper anti-rotation feature, while concurrently securing the pin to the bumper pin retainer. In certain embodiments, the support bolt may pass through the pin itself and be secured with a nut, or the support bolt may pass through a feature of the attachment system that facilitates retaining the pin to the bumper pin retainer. In certain embodiments, the support bolt may block rotation of the attachment interface relative to the bumper interface about the lateral axis, thereby eliminating the need for securing two anti-rotation features using a separate bolt.

In certain embodiments, the bumper pin retainer may include a hook feature that may include a first hook feature arm and a second hook feature arm separated by an open slot. The hook feature may be configured to receive a second hook feature (e.g. of the attachment pin retainer) via the open end of the open slot. The hook feature may be configured to receive the second hook feature (e.g., one arm of the second hook feature) at a closed end of the open slot, which is between the first hook feature arm and the second hook feature arm, at the first hook feature arm, and at the second hook feature arm. The closed end of the open slot may be located at a lower height (e.g. relative to the ground) than the open end of the open slot, such that the second hook feature (e.g. one arm of the second hook feature) may be disposed into the open slot. In certain embodiments, the second hook feature of the attachment pin retainer includes a third hook feature arm and a fourth hook feature arm separated by a second open slot. The width of the fourth hook feature arm (e.g. the hook feature arm closest to the bumper interface) may be smaller than the width of the open slot (e.g. defined by the width of the open slot), thereby enabling the hook feature to retain the fourth hook feature arm of the second hook feature. In a similar manner, the width of the second hook feature arm of the hook feature (e.g. the hook feature arm closest to the attachment interface) may be smaller than the width of the second open slot (e.g. defined by the width of the second open slot), thereby enabling the second hook feature to retain the second hook feature arm of the hook feature and enabling the hook feature and second hook feature to interlock together. The aforementioned second hook feature is used in place of the pin described in previous embodiments.

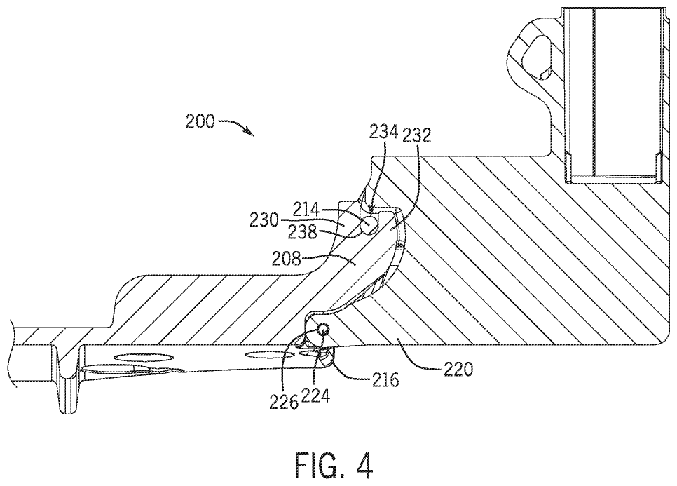

FIG. 4 is a cross-sectional view of the attachment system 200 of FIG. 2, taken along line 4-4 of FIG. 2, in accordance with an aspect of the present disclosure. In the illustrated embodiment, the pin 214 is shown to be retained by the open slot 234 of the bumper interface 208, such that the pin 214 is engaged with the closed end 238 of the open slot 234, the first hook feature arm 230, and the second hook feature arm 232. The attachment anti-rotation feature 220 is shown as contacting the bumper anti-rotation feature 216. In response to the attachment anti-rotation feature 220 making contact with the bumper anti-rotation feature 216, the hole(s) 224 of the attachment anti-rotation feature 220 align with the hole(s) of the bumper anti-rotation feature 216. The attachment anti-rotation feature 220 is secured to the bumper anti-rotation feature 216 via a bolt 226 concurrently retained by the hole(s) 224 of the attachment anti-rotation feature 220 and the bumper anti-rotation feature 216. The process of attaching attachment interface to the bumper interface 208 begins by lifting the attachment interface and the weights (e.g., via a crane), and aligning the pin 214 with the open slot 234 of the bumper interface 208. The attachment interface is lowered vertically, thereby lowering the pin 214 into the open slot 234. The attachment interface is then rotated downward about the pin 214, such that the hole(s) of the bumper anti-rotation feature 216 align with hole(s) 224 of the attachment anti-rotation feature 220. A bolt 226 is then inserted into the bumper and attachment anti-rotation feature hole(s) 224, such that the bolt is concurrently retained by both sets of hole(s), thereby blocking rotation of the attachment interface about the pin 214.

While only certain features have been illustrated and described herein, many modifications and changes will occur to those skilled in the art. It is, therefore, to be understood that the appended claims are intended to cover all such modifications and changes as fall within the true spirit of the disclosure. While one side of the attachment system is disclosed above, the same structure and variations are used on the other side of the attachment system.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An attachment system for a bumper of a work vehicle, wherein the attachment system comprises a bumper interface configured to support a substantially downward load exerted by an attachment interface, the bumper interface comprising:
a bumper pin retainer configured to retain a pin, the pin configured to couple to the attachment interface, and the pin configured to transfer the substantially downward load exerted by the attachment interface to the bumper interface; and
a bumper anti-rotation feature configured to block rotation in a first direction of the attachment interface about the pin.

2. The attachment system of claim 1, wherein the bumper pin retainer comprises a hook feature, the hook feature comprises a first arm and a second arm separated by an open slot, and the hook feature is configured to receive the pin via the open slot.

3. The attachment system of claim 1, wherein the bumper anti-rotation feature comprises a first anti-rotation arm and a second anti-rotation arm separated by a gap.

4. The attachment system of claim 3, wherein the attachment interface comprises an attachment anti-rotation feature, the attachment anti-rotation feature comprising a third anti-rotation arm.

5. The attachment system of claim 4, wherein the gap is configured to receive the third anti-rotation arm.

6. The attachment system of claim 4, wherein the bumper anti-rotation feature is configured to:
contact the attachment anti-rotation feature of the attachment interface; and
support a second load exerted by the attachment anti-rotation feature.

7. The attachment system of claim 4, wherein the bumper anti-rotation feature is configured to align a first hole of the bumper anti-rotation feature with a second hole of the attachment anti-rotation feature.

8. The attachment system of claim 7, wherein the first hole and the second hole are configured to retain a fastener, and the fastener is configured to block rotation in a second direction opposite the first direction of the attachment interface about the pin.

9. An attachment system for a bumper of an agricultural vehicle, wherein the attachment system comprises an attachment interface configured to support a substantially downward load exerted by a weight coupled to the attachment interface, the attachment interface comprising:
an attachment pin retainer configured to retain a pin, the pin configured to couple to a bumper interface, the pin configured to transfer the substantially downward load from the attachment interface to the bumper interface; and
an attachment anti-rotation feature configured to block rotation of the attachment interface about the pin.

10. The attachment system of claim 9, wherein the bumper interface comprises a bumper pin retainer.

11. The attachment system of claim 10, wherein the bumper pin retainer comprises a hook feature, the hook feature comprises a first arm and a second arm separated by an open slot, and the hook feature is configured to receive the pin via the open slot.

12. The attachment system of claim 9, wherein the attachment pin retainer comprises a first eyelet configured to retain the pin.

13. The attachment system of claim 12, wherein the attachment pin retainer comprises a second eyelet separated by a gap from the first eyelet, the second eyelet configured to retain the pin.

14. The attachment system of claim 9, wherein the attachment anti-rotation feature is configured to contact a bumper anti-rotation feature of the bumper interface to block rotation of the attachment interface about the pin.

15. The attachment system of claim 14, wherein the attachment anti-rotation feature is configured to align one or more first holes of the attachment anti-rotation feature with one or more second holes of the bumper anti-rotation feature.

16. The attachment system of claim 15, wherein the one or more first holes and the one or more second holes are configured to retain a fastener, and the fastener is configured to block rotation of the attachment interface about the pin.

17. An attachment system for a bumper of a work vehicle, comprising:
a bumper interface configured to support a substantially downward load exerted by an attachment interface, the bumper interface comprising:
a bumper pin retainer configured to retain a pin, the pin configured to couple to the attachment interface, and the pin configured to transfer the substantially downward load exerted by the attachment interface to the bumper interface; and
a bumper anti-rotation feature configured to block rotation of the attachment interface about the pin; and
the attachment interface configured to support the substantially downward load exerted by a weight coupled to the attachment interface, the attachment interface comprising:
an attachment pin retainer configured to retain the pin, the pin configured to couple to the bumper interface, the pin configured to transfer the substantially downward load from the attachment interface to the bumper interface; and
an attachment anti-rotation feature configured to contact the bumper anti-rotation feature to block rotation of the attachment interface about the pin.

18. The attachment system of claim 17, wherein the bumper pin retainer comprises a hook feature, the hook feature comprising a first arm and a second arm separated by an open slot.

19. The attachment system of claim 18, wherein the hook feature is configured to receive the pin via the open slot and retain the pin in a closed end of the open slot.

20. The attachment system of claim 19, wherein the attachment pin retainer comprises a first eyelet feature and a second eyelet feature separated by a gap, the first eyelet feature and the second eyelet feature configured to retain the pin.
